(19) United States
(12) Patent Application Publication
(10) Pub. No.: US 2025/0296838 A1
(43) Pub. Date: Sep. 25, 2025

(54) TRI-REFORMING OF METHANE TO HYDROGEN, METHODS FOR PREPARATION OF THE SAME, AND APPLICATIONS THEREIN

(71) Applicant: ARAMCO SERVICES COMPANY, Houston, TX (US)

(72) Inventors: Elizabeth Q. Contreras, Houston, TX (US); Xiao Jiang, Stoneham, MA (US); Sampath K. Bommareddy, Sugarland, TX (US)

(73) Assignee: ARAMCO SERVICES COMPANY, Houston, TX (US)

(21) Appl. No.: 18/611,221

(22) Filed: Mar. 20, 2024

(51) Int. Cl. C01B 3/48; B01D 53/00; B01D 53/047; B01D 53/22; B01J 8/04; C01B 3/06; C01B 3/38; C10G 2/00

(52) U.S. Cl. CPC C01B 3/48; B01D 53/002; B01D 53/047; B01D 53/229; B01J 8/0492; C01B 3/065; C01B 3/382; C01B 3/386; C10G 2/30; B01D 2253/116; B01D 2256/16; B01D 2256/22; B01D 2257/304; B01D 2257/502; B01D 2257/504; C01B 2203/0233; C01B 2203/0238; C01B 2203/0261; C01B 2203/0283; C01B 2203/047; C01B 2203/062; C01B 2203/0883; C01B 2203/1241; C01B 2203/127

(57) ABSTRACT

A process for a low-carbon footprint hydrogen production includes producing natural gas from a reservoir. The natural gas is sweetened to produce a sweet natural gas and an acid gas stream. The sweet natural gas is fed to a methane purification unit and purified to remove residual hydrogen sulfide. The acid gas stream is fed to a carbon dioxide feed purification unit and the carbon dioxide in the acid gas stream is purified. The purified methane, the purified carbon dioxide and steam are fed as reactants to a tri-reforming reactor, containing a tri-reforming catalyst, to produce a reaction effluent comprising hydrogen and carbon monoxide. An effluent is recovered from the tri-reforming reactor, which is then separated to recover a raw hydrogen stream and a raw carbon monoxide stream. The raw hydrogen stream is purified to recover a purified hydrogen stream, which is liquified to recover a liquid hydrogen product.

### FIELD OF DISCLOSURE

Embodiments disclosed herein relate to tri-reforming of methane utilizing two greenhouse gases, CH₄ and CO₂, to produce H₂ as a sustainable low-carbon fuel source.

### BACKGROUND

Hydrogen is emerging as a major source of energy because the only byproduct of combustion of H₂ with oxygen is water. Hydrogen must be manufactured in scalable processes because it cannot be found in large quantities in nature and cannot be mined or produced directly from reservoirs.

Various methods have been or are being developed to produce hydrogen at a commercial scale. One method currently used to produce H₂ in large quantities is methane cracking, in which methane is heated to high enough temperatures (greater than 300° C., for example) to produce hydrogen and carbon black. When biomethane is used, the resulting hydrogen is termed “turquoise hydrogen.”

Electrolysis of water, where electrical energy used to split water into hydrogen and oxygen, can also be used to produce hydrogen. “Green hydrogen” is hydrogen produced by electrolysis of water using electricity sourced from renewable energy sources, whereas Pink hydrogen is hydrogen produced by electrolysis using electricity sourced from nuclear power plants, and Gold hydrogen using electricity from standard electrical power grids.

These methods have lower environmental effects, in comparison to Gray and Blue Hydrogen processes, which refer to hydrogen produced by steam reforming of methane (CH₄+2 H₂O→4 H₂+CO₂). Gray Hydrogen produced by hydrocarbon, mostly natural gas and causing carbon dioxide (CO₂) emissions in the process, may currently be the most economically favorable. Blue Hydrogen is also produced by hydrocarbons, also causes CO₂ emissions, but is combined with carbon capture, storage, and utilization (CCSU) (when 90%+ emitted CO₂ for carbon capture, utilization, and storage) towards decarbonization. Briefly for Gray hydrogen, methane (CH₄) from natural gas and heated water (H₂O) causes CH₄ to split in the reformer into hydrogen (H₂) and CO₂, where CO₂ is separated (requiring energy input) and H₂ is purified. Carbon capture requires further energy input.

Unfortunately, both methane cracking and electrolysis of water have significant drawbacks. Methane cracking produces significant greenhouse gases and electrolysis is energy intensive. Further, steam reforming of methane causes either significant emissions or requires significant investment in CCSU. Accordingly, there exists a need to develop alternative processes to produce H₂ in large quantities in an environmentally friendly manner.

### SUMMARY

Embodiments herein relate to systems and processes that may be used to produce hydrogen at industrial scale. Integration of environmentally sustainable hydrogen production into current infrastructures is key for more favorable economic assessments of novel production method like the one described here: improvements in reducing electrolysis technologies, decreasing use of electricity, towards decarbonization of the transport sector by using hydrogen.

In one aspect, embodiments disclosed herein relate to process for a low-carbon footprint hydrogen production. The process includes producing natural gas from a reservoir, the natural gas comprising methane and one or more acid gases including hydrogen sulfide and carbon dioxide. The natural gas is sweetened to produce a sweet natural gas and an acid gas stream comprising the carbon dioxide. The process then includes feeding the sweet natural gas to a methane purification unit and purifying the sweet natural gas to remove residual hydrogen sulfide and to recover purified methane, as well as feeding the acid gas stream to a carbon dioxide feed purification unit and purifying the carbon dioxide in the acid gas stream and to recover purified carbon dioxide. The purified methane, the purified carbon dioxide and steam are fed as reactants to a tri-reforming reactor, containing a tri-reforming catalyst, to produce a reaction effluent comprising hydrogen and carbon monoxide. An effluent is recovered from the tri-reforming reactor comprising unreacted reactants, hydrogen, and carbon monoxide, which is then separated to recover a raw hydrogen stream and a raw carbon monoxide stream. The raw hydrogen stream is purified to recover a purified hydrogen stream, and the purified hydrogen stream is liquified to recover a liquid hydrogen product.

In some embodiments, water and the raw carbon monoxide stream are fed to a second reactor, reacting the water and the carbon monoxide to produce a second effluent comprising carbon dioxide and hydrogen. The second effluent is then separated to recover a second raw hydrogen stream and a raw carbon dioxide stream. The raw carbon dioxide stream may be fed to the carbon dioxide feed purification unit, and the second raw hydrogen stream may be mixed with the raw hydrogen stream prior to purifying the mixed raw hydrogen streams to produce the purified hydrogen stream.

In another aspect, embodiments herein relate to a process for low-carbon hydrogen production. The process includes feeding a methane feed stream, comprising methane and one or more impurities, to a methane purification unit, purifying the methane feed stream to remove impurities, and recovering a purified methane. The process also includes feeding a carbon dioxide feed stream, comprising carbon dioxide and one or more impurities, to a carbon dioxide feed purification unit, purifying the carbon dioxide in the carbon dioxide feed stream and recovering a purified carbon dioxide. The purified methane, the purified carbon dioxide and steam are fed as reactants to a tri-reforming reactor comprising a tri-reforming catalyst, the reactants contacting the tri-reforming catalyst at reaction conditions suitable to produce hydrogen and carbon monoxide. An effluent is recovered from the tri-reforming reactor comprising unreacted reactants, hydrogen, and carbon monoxide, which is then separated to recover a raw hydrogen stream and a raw carbon monoxide stream. The raw hydrogen stream is purified to recover a purified hydrogen stream, which is then liquified to recover a liquid hydrogen product.

In yet another aspect, embodiments herein are directed toward systems for a low-carbon footprint production of hydrogen. The systems include a natural gas purification unit configured to receive a natural gas stream, comprising methane and one or more acid gases including hydrogen sulfide and carbon dioxide, and to separate the natural gas stream into a sweet natural gas stream and an acid gas stream. A methane purification unit is provided to receive and purify the sweet natural gas stream to remove residual hydrogen sulfide and to produce a purified methane. A carbon dioxide purification unit is provided to receive and purify the acid gas stream to remove residual impurities and to produce a purified carbon dioxide. The system also includes a tri-reforming reactor containing a tri-reforming catalyst configured for contacting the purified methane, the purified carbon dioxide, water, and optionally oxygen, with the tri-reforming catalyst to produce an effluent comprising unreacted reactants, hydrogen, and carbon monoxide. A separation system is provided to separate the effluent to recover a raw hydrogen stream and a raw carbon monoxide stream. A hydrogen purification unit is configured to remove impurities in the raw hydrogen stream and to produce a purified hydrogen stream. The system further includes a hydrogen liquefication unit configured to compress and cool the purified hydrogen stream and to produce a liquid hydrogen product.

In some embodiments, the system further includes a second reactor configured to react the raw carbon monoxide stream and water to produce a second effluent comprising carbon dioxide and hydrogen. In such embodiments, a separation system may be provided for separating the second effluent to recover a second raw hydrogen stream and a raw carbon dioxide stream. A flow line is provided for feeding the second raw hydrogen stream to the hydrogen purification unit, and a second flow line is provided for feeding the raw carbon dioxide stream to the carbon dioxide purification unit.

Other aspects and advantages of the claimed subject matter will be apparent from the following description and the appended claims.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

FIG. 1 is a simplified process flow diagram of systems for the tri-reforming of methane to produce hydrogen according to embodiments herein.

FIG. 2 is a simplified process flow diagram of systems for the tri-reforming of methane to produce hydrogen according to embodiments herein.

FIGS. 3A and 3B show a thermodynamic comparison of tri-reforming processes herein and methane steam reforming.

FIGS. 4A and 4B show a comparison of CH₄ conversion and H₂ production from tri-reforming processes herein and methane steam reforming.

FIGS. 5A and 5B illustrates effects of H₂O/CH₄ ratio on tri-reforming processes herein and H₂ production.

FIGS. 6A and 6B illustrates effects of CO₂ concentrations on tri-reforming processes herein and H₂ production.

### DETAILED DESCRIPTION

In one aspect, embodiments disclosed herein relate to processes and systems that incorporate tri-reforming of methane, utilizing steam and two greenhouse gases, methane and carbon dioxide, to produce hydrogen as a sustainable low-carbon fuel. Conversion of methane in embodiments herein is based on a combination of reactions (tri-reforming) in a single reactor, akin to steam-methane reforming (SMR) and CO₂-methane reforming, to produce synthesis gas, or syngas, which is a mixture of hydrogen and carbon monoxide. Embodiments herein efficiently produce hydrogen from oxygenated molecules, such as carbon dioxide (CO₂) and water (H₂O). Where an anoxic environment is not achieved, the reactions can be driven to produce hydrogen, and embodiments herein provide for the mass production of hydrogen using parameters and reactive reagents conducive to hydrogen production.

Tri-reforming of natural gas according to embodiments herein combines CO₂ utilization, or carbon utilization, with the scalability and efficiency of steam methane reforming. The basic stoichiometry of the overall targeted reaction in embodiments herein is shown by the chemical reaction of Tri-Reforming Process (Eq. 1), where one mole of CO₂ is consumed for every eight moles of H₂ produced.

Tri-Reforming Process 1: 3CH₄+CO₂+2H₂O↔4CO+8H₂ (Eq. 1)

Overall, the reaction produces approximately 9.1 kg of H₂ and consumes 25 kg of CO₂. The tri-reforming process is endothermic with an overall heat of reaction of approximately 219.6 KJ/mol.

Other embodiments herein tri-reform methane in a reactor that combines steam reforming reactions (Eq. 2), dry reforming of methane (Eq. 3) and partial oxidation of methane (Eq. 4).

Steam Reforming: H₂O+CH₄↔CO+3H₂ (Eq. 2)

Dry Reforming: CO₂+CH₄↔CO+2H₂ (Eq. 3)

Partial Oxidation: 2CH₄+O₂↔2CO+4H₂ (Eq. 4)

The resulting combined reaction targeted by such embodiments may be represented by Tri-Reforming Process 2 (Eq. 5).

Tri-Reforming Process 2: 4CH₄+CO₂+H₂O+O2↔5CO+9H₂ (Eq. 5)

Various additional reactions may also occur in the tri-reforming reactor, including methane cracking (Eq. 6), the Boudouard reaction (Eq. 7), water gas shift reaction (Eq. 8), and complete oxidation of carbon (Eq. 9).

Methane Cracking: CH₄↔C+2H₂ (Eq. 6)

Boudouard: 2CO↔C+CO₂ (Eq. 7)

Water-gas shift: C+H₂O↔CO+H₂ (Eq. 8)

Complete Oxidation: C+O₂↔CO₂ (Eq. 9)

Feeds to systems according to embodiments herein targeting Tri-Reforming Reaction 1 may include water, carbon dioxide, and methane. Embodiments herein targeting Tri-Reforming Reaction 2 may utilize feeds that include water, carbon dioxide, oxygen, and methane.

As outlined above, some embodiments herein do not intentionally include an oxygen (O₂) feed. However, with oxygenated species such as water and carbon dioxide, embodiments herein can produce hydrogen and may purify or convert waste streams from anoxic reactions or may provide for carbon capture and sequestration, by including reaction step(s) for oxygenated species.

Methane feeds, or both methane and carbon dioxide feeds, may be provided according to embodiments herein via a natural gas stream. For example, a natural gas stream produced from a reservoir may be fed to a gas plant to separate the methane from natural gas liquids and acid gas components, such as carbon dioxide and hydrogen sulfide, contained in the natural gas, producing a sweet natural gas containing primarily methane. In various embodiments, natural gas produced as a result of carbon dioxide flooding may include significant quantities of both methane and carbon dioxide. In other embodiments, carbon dioxide used in the tri-reforming reactions herein may be sourced from reservoirs (CO₂ storage reservoirs, hydrocarbon producing reservoirs, etc.), or from industrial sources (refining, cement, manufacturing or energy production facilities combusting hydrocarbons to produce energy, for example), or other sources monitoring pH fluids, to sequester or capture waste carbon dioxide.

Using natural gas as a feedstock, for example, embodiments herein seek to produce H₂ with a reduced carbon footprint by incorporating CO₂ into the traditional methane steam reforming as a soft oxidant, where, in Eq. 1, one mole of CO₂ can produce up to eight moles of H₂ for a CO₂-rich CH₄ feedstock (sweet natural gas) as a new source in the production of sustainable fuels to meet increasing commitments towards a sustainable low-carbon economy and sustainable energy. Embodiments herein thus use two major greenhouse gases, CH₄ and CO₂, to produce H₂. CO₂ is a soft oxidant like water (steam) and oxygen (oxidation/combustion reactions), which reforms with CH₄ into H₂ (Eq. 1). Based on the stoichiometry, producing 9.1 kg of H₂ consumes 25 kg of CO₂, where having CO₂ as a soft oxidant promotes H₂ formation.

The natural gas feed stream may be provided by industrial processes, such as oil and gas wells that produce sweet or sour natural gas or produce natural gas as an undesired byproduct. Various industrial streams resulting from processing of crude oils, as well as natural gas streams as produced from a reservoir, may contain an amount of hydrogen sulfide and methane. Natural gas streams may be lean or rich in hydrogen sulfide, and in oil and gas operations, gas produced from conventional or unconventional fields can have varying sulfur content on an average of around 1-10% (v/v) H₂S; with ultra-high H₂S wells producing 25-90% (v/v) H₂S. At the wellhead, sour natural gas compositions may include 40-90% hydrogen sulfide, for example. Natural gas streams as produced from a well may also include various other components, such as water, oxygen, and carbon dioxide, among other impurities such as nitrogen, mercury, helium, and various other impurities as known in the art.

Embodiments herein thus separate a natural gas feedstock to produce a methane stream and a carbon dioxide stream. To minimize side reactions that may produce undesired byproducts and to limit introduction of catalyst poisons, the methane stream may be fed to a methane feed purification unit to remove trace impurities. Similarly, the carbon dioxide stream may be fed to a carbon dioxide feed purification unit to remove trace impurities.

While the feed purification steps required may vary according to the feed composition, initial feed separation and purification may include absorption columns, stripping columns, distillation columns, incineration processes, scrubbers, membrane separators, compressors, cooling systems, heating systems, centrifugation, chemical scavenging, filtration, dialysis, size-exclusion chromatography, sublimation, precipitation, volatilization, electrodeposition, extraction, and chromatography.

Initial separations of the methane-containing streams, such as a natural gas, to recover methane and carbon dioxide may provide respective streams that are 98+% pure. Impurities that remain may include levels of hydrogen sulfide, oxygen, and water, ranging from 0 to 40 ppb of each, for example. It may be desirable to limit or control an amount of these additional components, such as hydrogen sulfide, and thus each of the methane and carbon dioxide streams may be further purified to remove the remaining trace amounts of sulfur-containing compounds.

As oxygenated species may contribute to the reactions to produce hydrogen according to embodiments herein, purification steps to remove residual amounts of oxygenated species, such as using oxygen scavengers, is not needed. In other embodiments, such as where it is desired to maintain precise control over the reaction feed components, including each of methane, carbon dioxide, and water, and the resulting reaction stoichiometry within the tri-reforming reactors, it may be desirable to remove trace oxygenated components from the methane stream. In such embodiments, the oxygenated species recovered from purification of the methane stream may be utilized as a source of oxygenated species controllably fed as reactants to the tri-reforming reactor(s).

In some embodiments, for example, the methane purification may include a cooler and phase separator to drop out condensable components before the methane is passed through molecular sieve beds or membrane separation systems to further remove trace hydrogen sulfide, water and other impurities. Similarly, in some embodiments, CO₂ purification may include a cooler and phase separator to drop out condensable components before the CO₂ is passed through molecular sieve beds to further remove trace hydrogen sulfide, water and other impurities.

Following feed preparation, the purified methane, purified carbon dioxide, and water (steam) may be fed to a catalytic reaction zone including one or more tri-reforming reactors, arranged in series and/or parallel, to produce a synthesis gas. In other embodiments, following feed preparation, the purified methane, purified carbon dioxide, oxygen, and water (steam) may be fed to a catalytic reaction zone including one or more tri-reforming reactors, arranged in series and/or parallel, to produce a synthesis gas.

The tri-reforming reaction according to Eq. 1 (Tri-Reforming Reaction 1) stoichiometrically requires three moles of methane per mole of carbon dioxide. The tri-reforming reaction according to Eq. 5 (Tri-Reforming Reaction 2) stoichiometrically requires four moles of methane per mole of carbon dioxide. The feed streams provided to the system that result from the upstream natural gas separations, however, may have varying amounts of these components, and which may depend upon the reservoir being produced or the other industrial processes from which the gas mixture being processed is sourced.

Methane and carbon dioxide may be fed to the tri-reforming reactor at a molar ratio in a range from 1:7 to 7:1. The ratio of CH₄ to carbon dioxide in the total reactor feed in various embodiments is in a range from 1:6 to 6:1, such as in a range from 1:3 to 3:1, or from 3:2 to 6:1 in other embodiments.

Methane and water may be fed to the tri-reforming reactor at a molar ratio in a range from 1:5 to 5:1. The ratio of CH₄ to steam (i.e., H₂O) in the total reactor feed in various embodiments is in a range from 1:4 to 4:1, such as in a range from 1:3 to 3:1. In some embodiments, the ratio of CH₄ to steam is controlled to maintain the CH₄:H₂O ratio in the feed between 3:1 and 3:4. In some embodiments, steam may be increased to reduce coking, and may be fed to the reactor at a methane to steam ratio in a range from 1:2 to 1:3, for example. Thermodynamic calculations also suggest that an increase in steam also supports improved CH₄ conversion and H₂ production.

Water and carbon dioxide may be fed to the tri-reforming reactor at a molar ratio in a range from 1:3 to 3:1. The ratio of water to carbon dioxide in the total reactor feed in various embodiments is in a range from 1:2 to 2:1, such as in a range from 1:1 to 2:1 in other embodiments. Regarding water to carbon dioxide ratios, thermodynamic calculations indicate that a stoichiometry of water to carbon dioxide of 2:1 shows a higher hydrogen production, which a ratio of 1:1 shows a slight decrease. However, a further reduction in carbon dioxide composition in the feed results in a further decrease in hydrogen production.

Water, methane, and carbon dioxide may be fed to the tri-reforming reactor at a molar ratio in a range from 4:6:1 to 2:3:2, for example.

In embodiments tri-reforming according to Tri-Reforming Reaction 2, methane and oxygen may be fed to the tri-reforming reactor at a molar ratio in a range from 1:1 to 4:1. Due to use of water and carbon dioxide as soft oxidants, methane should be in excess. In such embodiments, methane, water, and carbon dioxide may be provided at the ratios as described above.

Tri-reforming catalysts that may be used in the tri-reforming reactor may include supported nickel or noble metal-based oxide catalysts. Catalyst support materials may include metal oxides or mixed metal oxides, such as oxides of silicon, magnesium, aluminum, titanium or zirconium, for example.

Tri-reforming catalysts that may be used in the tri-reforming reaction may include a heterogeneous site-isolated catalyst and may be configured for wet continuous processing or in a dry column configuration. Heterogeneous site-isolated catalysts consist of multiple catalysts of various chemical compositions within a capsule. These compositions may vary based on a semi-permeable shell membrane (aliphatic vs. aromatic compositions), the catalyst or reactive reagent housed within, the empty core, the tethering polymers, or the chemistries of the capsule (chemical initiators, photophores, oxygen scavengers, buffers, nanoparticles, titania, gold, iron, or carbon). Both single or multiple varieties of reactive capsules may be used to facilitate the reactions for higher efficiency and yield. The catalyst may be an inorganic-organic hybrid structure comprised of a highly crosslinked organic shell and a site-isolated catalyst in its core. Catalysts may be site-isolated by housing the catalyst within a micro-environment, allowing easy separation, recycling, and reuse of catalysts. Using a shell vesicular membrane for the catalyst may improve catalyst lifespan. In other embodiments, the transparency of a high-molecular weight semi-permeable membrane of the catalyst allows for an irradiation catalyzed reaction to initiate hydrogen production. Site-isolated catalysts may prevent budding and fusing, and catalyst aggregation and precipitation. Budding may cause single point growth, ineffectively reducing the catalyst concentration in the solution. Fusing may result in small volume particles combining into larger volume particles, ineffectively reducing surface area and decreasing catalyst efficiency. Site-isolated catalysts prevent catalytic reagents from forming an impermeable film where the polymer shell allows for diffusion to continue during the entire process because of the semi-permeable membrane. Catalyst aggregation may cause materials to aggregate irreversibly into larger volume particles. Precipitation caused by chemical instability such as catalyst fouling, or a decrease in solubility, may cause reactive incompatibility with contaminants. Any decrease in volume and surface area may cause a change in reaction efficiency. The catalyst may lower operating temperature and increase production yield.

The wet continuous processing configurations may use liquid solvents to suspend platform catalysts into solution. Examples of suitable liquid solvents include water, ethanol, diethyl ether, benzene, toluene, methanol, and acetone. The shell membrane is highly crosslinked and insoluble in both aqueous (acidic and alkaline) and organic solvents. This solution allows fluids to reach the heterogeneous catalyst while stirring or static, as fluids continuously permeate with reactive catalysts, converting the reactants into H₂ and CO, which may then permeate out. Housed in a semi-permeable membrane, the reactive catalyst reacts with incoming gases, including methane, water, and carbon dioxide. The reactants pass through the semi-permeable capsules and enter into the core to improve the proximity between reactants and the catalyst within the core. This structure allows reaction products to then escape and permeate outwardly through the semi-permeable capsule over time.

The dry packed adsorption column configurations may use a single column or multiple columns packed with a solid free-flowing powder catalyst. For multi-column systems, the beds of granular powder may be arranged in series, parallel, or lead lag configurations. A lead lag configuration consists of at least two beds in series and a bypass around the first bed. In this configuration of a packed bed column design, the first bed is designed to lead the catalytic reaction and the second bed follows behind it for any unreacted materials or reagents. If the first bed appears to be approaching exhaustion, it may be bypassed for the secondary bed that has been in use but to a lesser extent, allowing the first bed to be replenished. In some embodiments, both a dry and a wet column may be used to react and separate liquid/gas mixtures. In some embodiments, glass reactors, or glass-lined reactors may be used. The use of packed beds and sieved trays separates the products produced in the catalytic reaction.

The tri-reforming reactor may be operated at reaction conditions which may vary, depending upon the feed mixture, catalyst type, and other factors that may influence preferred temperatures, pressures, and throughput. In various embodiments, the tri-reforming reactor may be operated at temperatures in a range from 600° C. to 1100° C., such as in a range from 650° C. to 1050° C., from 700° C. to 1000° C., or from 750° C. to 900° C. In various embodiments, the tri-reforming reactor may be operated at pressures in a range from 0.8 or 0.9 bar to 25 bar, such as from 3 bar to 25 bar, or near or slightly above atmospheric pressure in other embodiments. Where it is desired to maintain a solubility between water and carbon dioxide, embodiments herein contemplate use of higher than typical steam methane reforming reactions, and may be operated at pressures, for example, in a range from 30 to 250 bar.

Following conversion, a reaction effluent recovered from the tri-reforming reactor may be separated to recover the desired products, hydrogen and carbon monoxide. The reaction effluent may additionally include unreacted feed components (methane, water, carbon dioxide) and undesired byproducts including carbon black and oxygen (O₂) gas.

In embodiments in which excess methane is fed to the reactor, or in which significant quantities of methane remain unreacted, the methane may be recovered separately and fed to downstream units for processing of the methane via normal processing routes for natural gas. The unreacted methane may be recovered, for example, and may be recycled for use in hydrogen production, combusted or partially combusted to provide energy to the feed streams or collected for other uses.

Separation of the reaction effluent may be conducted by various gas-gas and liquid-gas separation apparatus and processes. The separation processes may include compression, cooling, condensation, membrane separations, and other types of separation to separate and recover water, carbon monoxide, methane, and hydrogen. The extent and type of separation devices used may depend upon the required hydrogen purity, as well as the feed compositions/ratios, which may depend upon the natural gas source, and the anticipated reaction effluent compositions. The CO byproduct can be used in a water gas shift process to produce additional hydrogen.

Amine absorption and pressure swing adsorption are commonly used for CO₂ separations associated with similar applications, such as hydrogen purification from steam methane reforming and water-gas shift processes. Selection of the purification process depends on the H₂ purity requirements and the expected impurities. For example, amine absorbers can achieve over 98% H₂ purity, while pressure swing adsorption can produce better than 99% pure H₂. Amine absorbers are a better fit for bulk separations with a high concentration of CO₂ and are less problematic with many impurities. Carbon monoxide, being reactive, may be removed from the hydrogen stream by adsorption, absorption, or other means, such as oxygen scavenger units, to further sequester the carbon and purify the hydrogen.

Additional H2 is produced in some embodiments herein from the capture and utilization of the recovered carbon monoxide (CO) stream(s). The carbon monoxide product recovered from the tri-reforming reactor effluent and water may be fed to a carbon capture and utilization reactor, where the carbon monoxide is reacted with water to produce CO₂ and additional hydrogen via the water-gas shift reaction (WGS, Eq. 9). The carbon monoxide produced in the tri-reforming reactor thus becomes a feedstock for additional hydrogen production. The effluent from the carbon capture and utilization reactor is then separated to recover the hydrogen, which may be combined with the hydrogen product from the tri-reforming reactor. The carbon dioxide produced in the carbon capture and utilization reactor may be disposed of, or, in some embodiments, may be fed to the carbon dioxide purification unit for continued use in producing hydrogen.

The hydrogen product from the tri-reforming reactor, or the combined hydrogen from the tri-reforming reactor and the carbon capture and utilization reactor, is then fed to a product purification and liquification unit. In the hydrogen product purification and liquefaction unit, the raw hydrogen products recovered from the reactor effluents are purified to meet pipeline standards or other requirements for the hydrogen product, and the hydrogen is compressed and liquified for storage or transport.

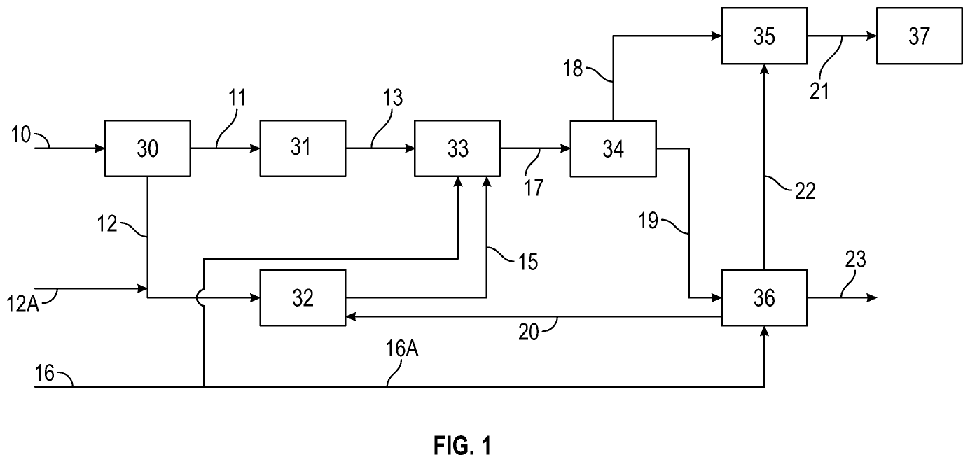

Referring now to FIG. 1, FIG. 1 illustrates a simplified process flow diagram of a tri-reforming process to produce hydrogen according to embodiments herein. In this embodiment, the tri-reforming reaction is conducted according to Tri-Reforming Reaction 1. Natural gas 10 is processed in gas plant 30 to produce a methane stream 11 and a carbon dioxide stream 12. The gas plant 30 may also remove valuable natural gas liquids and impurities, such as H₂S (not shown). The methane 11 is sent to a CH₄ purification unit 31 to remove trace impurities, such as H₂S, to reduce fouling, corrosion, or catalyst poisoning in the tri-reforming reactor unit or zone 33. The CO₂ coming from the gas plant 30 is sent to a CO₂ purification unit 32, similar to CH₄ purification unit 31, where CO₂ 12 is cooled and passed through a phase separator prior to final treatment to remove trace impurities in molecular sieve beds. If required to meet the desired feed ratio of carbon dioxide, additional CO₂ may be provided to the system upstream (as illustrated) or downstream of the CO₂ purification unit 32 via flow line 12A.

The purified CH₄ 13 and purified CO₂ 15 feeds are then fed to the tri-reforming reaction zone 33, which may include one or more tri-reforming reactors containing a tri-reforming catalyst. The purified feeds 13, 15 may be compressed and preheated (not shown) as needed to maintain the desired operating conditions in the tri-reforming reactors 33.

The tri-reforming effluent 17 is mainly syngas (H₂ and CO), along with any unreacted feed components, such as steam and a small amount of CO₂. The tri-reforming effluent 17 is sent to syngas separation unit 34. In separation unit 34, for example, the tri-reforming effluent 17 is cooled and an aqueous phase is separated before H₂ 18 is separated from the carbon monoxide 19. Membrane separations or pressure swing adsorption, for example, may be used to separate H₂ 18 from carbon monoxide 19.

The H₂ 18 from the syngas separation unit 34 is sent to a H₂ purification unit 35 before it is transferred to H₂ storage 37. Hydrogen purification may include, for example, pressure swing adsorption to remove small amounts of CO or CO₂ and other trace impurities. The resulting purified H₂ product 21 is then compressed and/or liquified for storage 37.

Tri-Reforming processes according to some embodiments herein are integrated with a carbon capture and utilization reaction zone 36. Carbon capture and utilization reaction zone 36 may include a water gas shift reactor, among other means for converting CO to useful end products, as well as separators for recovering the desired products. As illustrated, CO 19 produced in the tri-reforming reactor and recovered from the syngas is fed with steam 16A to a water gas shift reactor in reaction zone 36 to produce additional H₂ 22, which is separated from carbon dioxide in the water gas shift reactor effluent. This increases the overall amount of H₂ produced by the system (H₂ stream 18 plus H₂ stream 22), with one mole of excess CO₂ 20 produced for each mole of H₂ 18. A portion or an entirety of CO₂ resulting from the water gas shift reaction can be used further as a reactant in another reactor in the carbon utilization unit 36, such as to produce a gas-to-liquids product 23, or can be recycled back to the CO₂ purification unit 32 for continued use in tri-reforming unit 33.

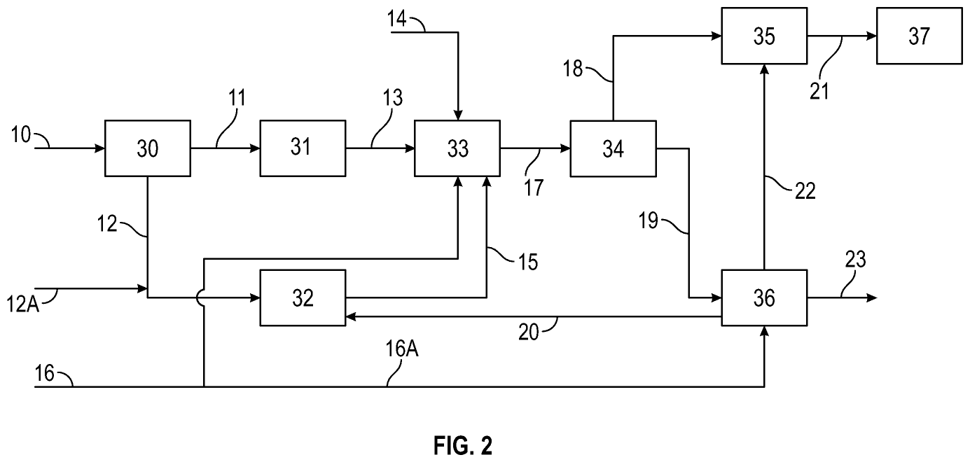

Referring now to FIG. 2, FIG. 2 illustrates a simplified process flow diagram of a tri-reforming process to produce hydrogen according to embodiments herein, where like numerals represent like parts. In this embodiment, the tri-reforming reaction is conducted according to Tri-Reforming Reaction 2, where in addition to the purified methane 13, purified carbon dioxide 15, and steam 16, oxygen 14 is also fed to the tri-reforming reactor. Oxygen 14, such as purified oxygen, oxygen-enriched air, or air, may be preheated and supplied to the tri-reforming unit 33 to contribute to the partial oxidation reaction and reduce coke formation on the catalyst. Preheated air or oxygen-enriched air may be used to supply oxygen 14 for the partial oxidation reaction and reduce nitrogen byproducts. Oxygen 14 feed to the tri-reforming unit 33 may also be adjusted to maintain catalyst activity, based on the temperature of the tri-reforming reactor and level of H₂ in the tri-reforming effluent 17.

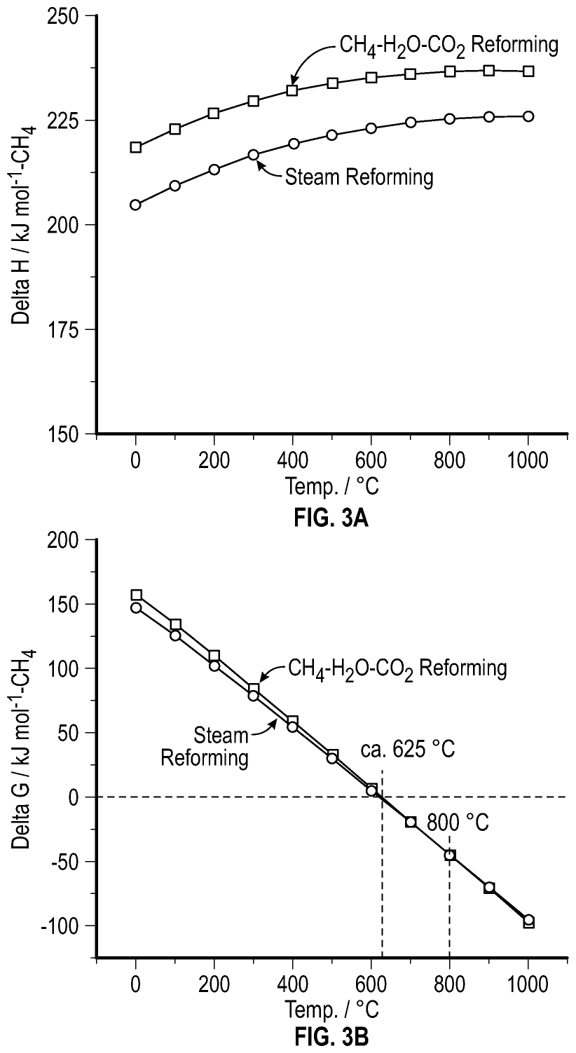

The thermodynamic analyses shown in FIGS. 3A and 3B provide a baseline for comparison of Tri-Reforming Reaction 1 and the well-established steam-methane reforming process. FIG. 3A shows a comparison of the enthalpy of reaction, Delta H, as a function of temperature. As shown, Tri-Reforming Reaction 1 requires approximately 6% more energy than methane steam reforming (FIG. 3A). Both Tri-Reforming Reaction 1 and methane steam reforming show similar trends in the change in Gibbs free energy of the system, Delta G (FIG. 3B). Both of these reforming reactions (Tri-Reforming Reaction 1 and methane steam reforming) become spontaneous when Delta G is negative, beyond 625° C.

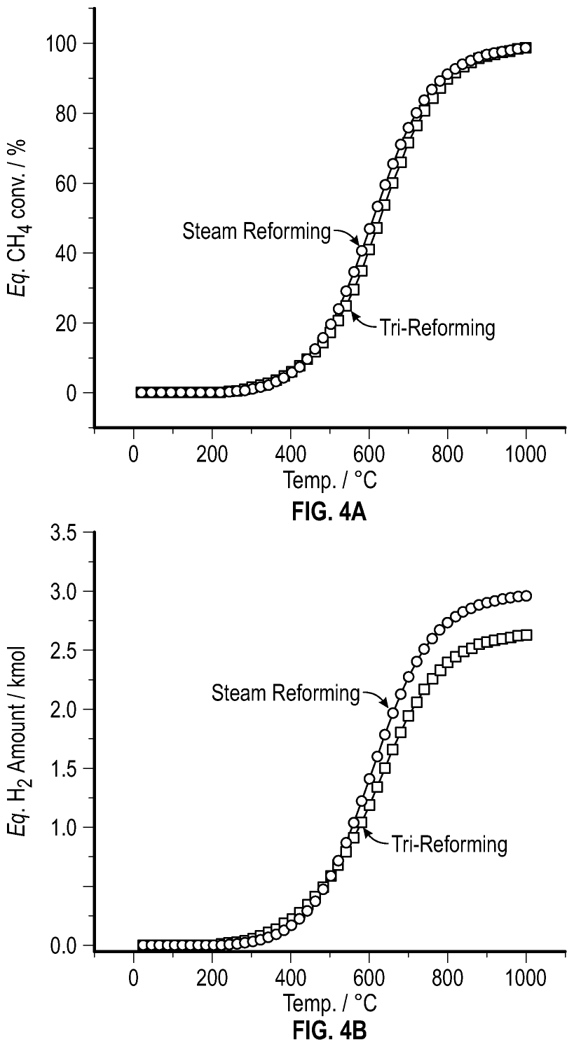

As illustrated in FIGS. 4A and 4B, Tri-Reforming Reaction 1 and steam methane reforming reactions show similar equilibrium conversion as the temperature rises. Steam reforming shows slightly higher H₂ production at higher temperatures (FIG. 4B). However, the Tri-Reforming Reaction 1 not only allows for a similar level of H₂ production, it ensures the CO₂ utilization with hydrogen production.

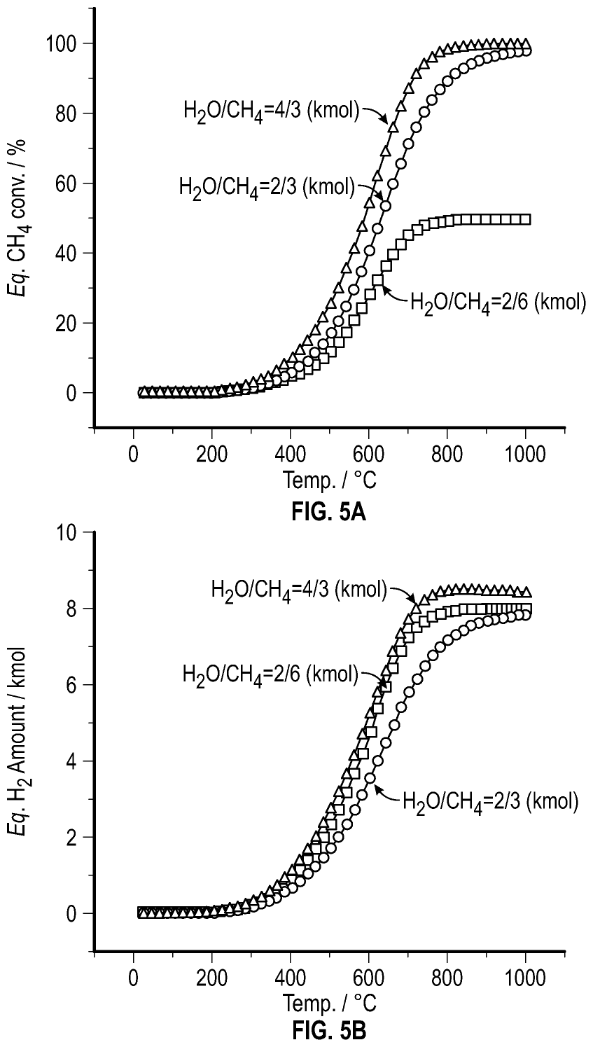

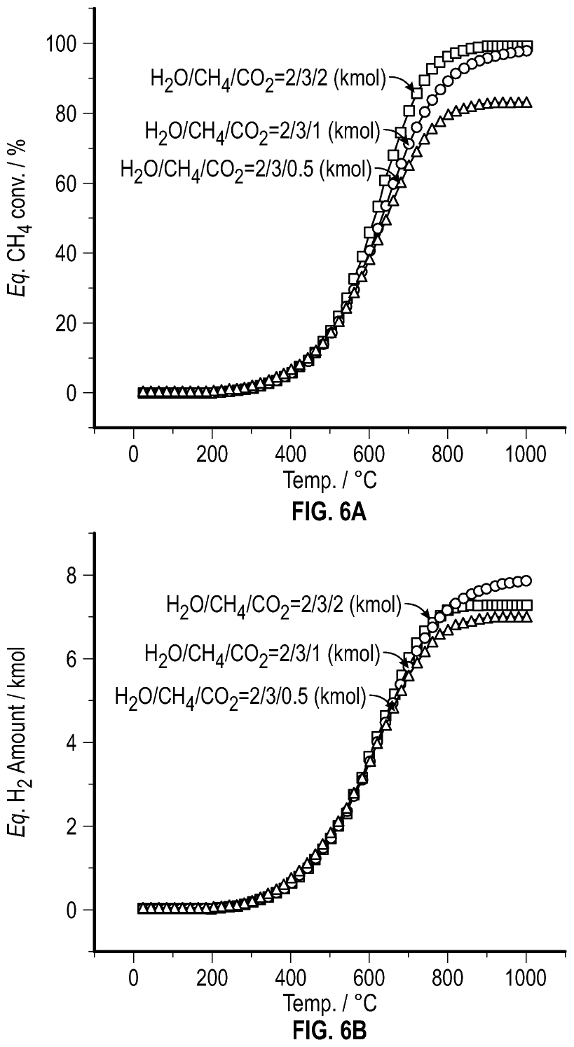

The predicted effects of H₂O/CH₄ and H₂O/CH₄/CO₂ ratios on equilibrium CH₄ conversion and H₂ production are shown in FIGS. 5A/5B and FIGS. 6A/6B. FIG. 5A/B illustrates that increasing the initial amount of either H₂O or CH₄ will benefit H₂ production for the tri-reforming reaction, especially in the same temperature range where methane steam reforming operates (e.g., approximately 700-1000° C.). Therefore, an elevated steam rate may be maintained to avoid coking. FIG. 6A/B indicates that changes in CO₂ concentrations have a significant effect on H₂ production output, and may be advantageous where the H₂O/CO₂ ratio remains at or above the stoichiometric amount of 2/1.

As described above, embodiments herein utilize a natural gas stream to provide methane or methane and carbon dioxide to a tri-reforming reactor to produce syngas. An H₂ product and CO byproduct are separated from the syngas. The H₂ product is sent to a final purification, compression and liquification stage before it is transferred to storage. The CO byproduct is used as feedstock for a carbon capture and utilization unit.

In some embodiments, as described above, the CO byproduct may be used in a water gas shift reactor to produce hydrogen. Another option is to send use the CO byproduct, or a portion of the syngas, as feedstock for a carbon utilization process for the synthesis of chemicals and fuels. Several commercially available gas to liquids and Fischer-Tropsch technologies utilizing carbon monoxide or syngas feeds are feasible for integration with the tri-reforming processes described herein. Thus, in addition to H₂ production, additional value-streams from reformation derived gases can be further used to produce valuable hydrocarbons in Fisher-Tropsch (FT) reactions for production of FT products such as hydrocarbons having two or more carbon atoms, FT waxes, synthetic oils, lubricants, diesel, and jet fuels. Linking FT processes with existing technologies for chemical production requires no separation step (which requires energy), but instead further lowers the carbon footprint.

Energy requirements for the hydrogen production processes herein may be provided by a green energy source (wind, water, etc.), so as to maintain a low carbon footprint. Additionally, or alternatively, embodiments herein may utilize a portion of the hydrogen produced as a fuel, the combustion of which may provide a portion of the heat required to produce the hydrogen. Higher carbon footprint means for providing heat, such as combustion of the methane, may also be used.

In some embodiments, heat from the exothermic water-gas shift reaction, or from partial oxidation of methane, may also be captured for use in providing heat to the tri-reforming reactions, as well as additional hydrogen production. Thus, embodiments herein may include generating energy via partial combustion of methane to form hydrogen and carbon monoxide, recovering the hydrogen, and transferring the energy to the steam, the purified carbon dioxide or the purified methane for use in the tri-reforming reaction.

In other embodiments, water-reactive chemicals, such as metal halides, may be used to provide energy needed to produce hydrogen according to the tri-reforming processes herein. Liquid water may be introduced into a hydrogen recovery unit for hydrolysis of the metal hydrides, such as a lithium-aluminum hydride, which releases the H₂. The recovered hydrogen may then be recovered along with the hydrogen produced by the tri-reforming process, or may transported for use by a power plant or fueling facility. The hydrolysis of metal hydrides releases significant amounts of heat producing a hot hydrolyzed carrier, and the heat may be recovered to offset energy needed for the tri-reforming and storage processes herein. For example, hydration of lithium-aluminum hydroxide may release up to 697 KJ/mol, which may provide ample energy for the tri-reforming reactions. Thus, embodiments herein may include generating energy via the reaction of a lithium-aluminum hydride with water to form a lithium-aluminum hydroxide (or a lithium hydroxide and an aluminum hydroxide) and hydrogen, recovering the hydrogen, and transferring the energy to the steam, the purified carbon dioxide or the purified methane for use in the tri-reforming reaction.

While contemplating use of metal hydrides as an energy source, embodiments herein further contemplate formation of metal hydrides as a means for storing the hydrogen produced from tri-reforming processes herein. Commercial processes for hydrogen storage currently use compression and liquefication for storage in pressurized vessels. Although liquefication is commercially viable, alternative methods of storage and transportation are being investigated to reduce the cost and improve efficiency. Metal-hydrides, such as LiAlH₄, can be formed by hydrogenating the metal salts. Hydrolysis of metal-hydrides, such as LiAlH₄, offers hydrogen density as high as 10.1 wt %, which is greater than the density of liquid H₂.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A process for low-carbon hydrogen production, the process comprising:
producing natural gas from a reservoir, the natural gas comprising methane and one or more acid gases including hydrogen sulfide and carbon dioxide;
sweetening the natural gas to produce a sweet natural gas and an acid gas stream comprising the carbon dioxide;
feeding the sweet natural gas to a methane purification unit and purifying the sweet natural gas to remove residual hydrogen sulfide and to recover purified methane;
feeding the acid gas stream to a carbon dioxide feed purification unit and purifying the carbon dioxide in the acid gas stream and to recover purified carbon dioxide;
feeding the purified methane, the purified carbon dioxide and steam as reactants to a tri-reforming reactor comprising a tri-reforming catalyst;
contacting the reactants with the tri-reforming catalyst to produce hydrogen and carbon monoxide according to the following reaction:
2H₂O+3CH₄+CO₂=8H₂+4CO
recovering an effluent from the tri-reforming reactor comprising unreacted reactants, hydrogen, and carbon monoxide;
separating the effluent to recover a raw hydrogen stream and a raw carbon monoxide stream;
purifying the raw hydrogen stream to recover a purified hydrogen stream;
liquifying the purified hydrogen stream to recover a liquid hydrogen product.

2. The process of claim 1, further comprising
feeding water and the raw carbon monoxide stream to a second reactor, reacting the water and the carbon monoxide to produce a second effluent comprising carbon dioxide and hydrogen; and
separating the second effluent to recover a second raw hydrogen stream and a raw carbon dioxide stream.

3. The process of claim 2, further comprising feeding the raw carbon dioxide stream to the carbon dioxide feed purification unit.

4. The process of claim 1, further comprising feeding a portion of the effluent to a Fischer-Tropsch reactor and converting the hydrogen and carbon monoxide to hydrocarbons having two or more carbon atoms.

5. The process of claim 1, wherein the reactants comprise water and carbon dioxide at a molar ratio of 1:7 to 7:1.

6. The process of claim 1, wherein the reactants comprise water and methane at a molar ratio of 1:5 to 5:1.

7. The process of claim 1, wherein the reactants comprise water, methane, and carbon dioxide at a molar ratio of 4:6:1 to 2:3:2.

8. The process of claim 1, wherein the tri-reforming reactor is operated at a temperature in the range of 700° C. to 1000° C. and a pressure in a range from 3 MPa to 25 MPa.

9. The process of claim 1, further comprising feeding oxygen to the tri-reforming reactor.

10. The process of claim 1, further comprising one or both of:
(a) generating energy via partial combustion of methane to form hydrogen and carbon monoxide, recovering the hydrogen, and transferring the energy to the steam, the purified carbon dioxide or the purified methane; and
(b) generating energy via the reaction of a lithium-aluminum hydride with water to from a lithium-aluminum hydroxide and hydrogen, recovering the hydrogen, and transferring the energy to the steam, the purified carbon dioxide or the purified methane.

11. A process for low-carbon hydrogen production, the process comprising:
feeding a methane feed stream, comprising methane and one or more impurities, to a methane purification unit, purifying the methane feed stream to remove impurities, and recovering a purified methane;
feeding a carbon dioxide feed stream, comprising carbon dioxide and one or more impurities, to a carbon dioxide feed purification unit, purifying the carbon dioxide in the carbon dioxide feed stream and recovering a purified carbon dioxide;
feeding the purified methane, the purified carbon dioxide and steam as reactants to a tri-reforming reactor comprising a tri-reforming catalyst;
contacting the reactants with the tri-reforming catalyst to produce hydrogen and carbon monoxide;
recovering an effluent from the tri-reforming reactor comprising unreacted reactants, hydrogen, and carbon monoxide;
separating the effluent to recover a raw hydrogen stream and a raw carbon monoxide stream;
purifying the raw hydrogen stream to recover a purified hydrogen stream;
liquifying the purified hydrogen stream to recover a liquid hydrogen product.

12. The process of claim 11, further comprising
feeding water and the raw carbon monoxide stream and water to a second reactor, reacting the water and the carbon monoxide to produce a second effluent comprising carbon dioxide and hydrogen; and
separating the second effluent to recover a second raw hydrogen stream and a raw carbon dioxide stream; and
feeding the raw carbon dioxide stream to the carbon dioxide feed purification unit.

13. The process of claim 11, further comprising feeding a portion of the effluent to a Fischer-Tropsch reactor and converting the hydrogen and carbon monoxide to hydrocarbons having two or more carbon atoms.

14. The process of claim 11, wherein the reactants comprise water, methane, and carbon dioxide at a molar ratio of 4:6:1 to 2:3:2.

15. The process of claim 11, further comprising feeding oxygen as a reactant to the tri-reforming reactor.

16. The process of claim 1, further comprising one or both of:
(c) generating energy via partial combustion of methane to form hydrogen and carbon monoxide, recovering the hydrogen, and transferring the energy to the steam, the purified carbon dioxide or the purified methane; and
(d) generating energy via the reaction of a lithium-aluminum hydride with water to from a lithium-aluminum hydroxide and hydrogen, recovering the hydrogen, and transferring the energy to the steam, the purified carbon dioxide or the purified methane.

17. A system for a low-carbon footprint production of hydrogen, the system comprising:
a natural gas purification unit configured to receive a natural gas stream, comprising methane and one or more acid gases including hydrogen sulfide and carbon dioxide, and to separate the natural gas stream into a sweet natural gas stream and an acid gas stream;
a methane purification unit configured to receive and purify the sweet natural gas stream to remove residual hydrogen sulfide and to produce a purified methane;
a carbon dioxide purification unit configured to receive and purify the acid gas stream to remove residual impurities and to produce a purified carbon dioxide;
a tri-reforming reactor containing a tri-reforming catalyst configured for contacting the purified methane, the purified carbon dioxide, water, and optionally oxygen, with the tri-reforming catalyst to produce an effluent comprising unreacted reactants, hydrogen, and carbon monoxide;
a separation system to separate the effluent to recover a raw hydrogen stream and a raw carbon monoxide stream;
a hydrogen purification unit configured to remove impurities in the raw hydrogen stream and to produce a purified hydrogen stream;
a hydrogen liquefication unit configured to compress and cool the purified hydrogen stream and to produce a liquid hydrogen product.

18. The system of claim 17, further comprising:
a second reactor, configured to react the raw carbon monoxide stream and water to produce a second effluent comprising carbon dioxide and hydrogen;
a separation system for separating the second effluent to recover a second raw hydrogen stream and a raw carbon dioxide stream;
a flow line for feeding the second raw hydrogen stream to the hydrogen purification unit; and
a flow line for feeding the raw carbon dioxide stream to the carbon dioxide purification unit.

19. The system of claim 17, further comprising a flow line for feeding oxygen to the tri-reforming reactor.

20. The system of claim 17, further comprising a Fischer-Tropsch reactor configured to receive a portion of the effluent and for converting the hydrogen and carbon monoxide to hydrocarbons having two or more carbon atoms.
